(19) United States
(12) Patent Application Publication
(10) Pub. No.: US 2026/0324605 A1
(43) Pub. Date: Oct. 22, 2026

(54) SYSTEM AND METHOD FOR BIOMASS DENSIFICATION

(71) Applicant: East Coast Innovation Inc., Saint Andrews (CA)

(72) Inventors: Joel Benjamin HALSE, Saint Andrews (CA); David Werner FALKJAR, Upper Letang (CA); Max David FALKJAR, Saint John (CA); Jonathan Geoffrey HALSE, Saint Andrews (CA)

(21) Appl. No.: 19/108,656

(22) PCT Filed: Sep. 27, 2023
(86) PCT No.: PCT/CA2023/051278

§ 371 Date: Mar. 4, 2025

Related U.S. Application Data
(60) Provisional application No. 63/410,830, filed on Sep. 28, 2022.

(51) Int. Cl. A01K 63/04; B01D 29/44; B01D 35/02; C02F 1/00

(52) U.S. Cl. CPC A01K 63/045; A01K 63/047; B01D 29/445; B01D 35/02; C02F 1/004; B01D 2201/204; C02F 2209/40; C02F 2301/046

(57) ABSTRACT

A biomass densification system is disclosed comprising a biomass densification unit having a body defining an inlet and an outlet and comprising a densification filter on the body, the inlet configured to receive an input stream including a target biomass and having a first biomass density, and the densification filter configured to allow fluid flow therethrough and configured to prevent passage of the target biomass therethrough; and a suction pump configured to produce a suction force across the densification filter at or below a threshold, the suction force configured to draw the input stream through the densification filter for producing a biomass residue stream separate from a filtrate stream, the biomass residue stream configured to direct the target biomass toward the outlet at a second biomass density, wherein the second biomass density is greater than the first biomass density.

### CROSS-REFERENCE TO RELATED APPLICATIONS

This application claims priority to United States Provisional Application number U.S. 63/410,830, filed Sep. 28, 2022, all of which is incorporated by reference in its entirety.

### FIELD

The present disclosure relates generally to densification of biomass, including but not limited to a system and method for densification of biomass in aquaculture.

### BACKGROUND

The following paragraphs are not an admission that anything discussed therein is prior art, or part of the knowledge of persons skilled in the art.

Industrial fish farming requires the movement of large populations of fish at several different stages in the farming process. This is done using fish pumping systems that move large volumes of water and any fish contained in that water. The fish are moved to an input of a pump and then drawn into a pumping system. The instinctive response of fish to the currents and conditions created by the pumping system is to swim against the current and away from the pump.

Current approaches fish pumping systems can include physically crowding the fish to be moved into the volume of the water being drawn into the pump and forcing them into the pumping system as they attempt to swim away. Because the fish are attempting to swim away from the pump suction, the pump draws water through the population of fish, drawing more water than fish, causing a decrease in biomass density between the area in which the fish are crowded and the flow within the pump. The resulting decrease in biomass density means that the biomass density in the area in which the fish are crowded, and thus the biomass density of the source population of fish, must be held at a higher level than the optimal operating biomass density of the pump. This method of crowding and handling of the fish has many negative effects on fish health, which is made worse by an extended period of stress during the fish's attempt to escape. Conditions worsen as time progresses for the population of fish waiting in crowded conditions, until they are drawn into the pump. Depending on the number of fish to be moved and pumping system capacity, these conditions can last hours and create a dynamic where pumping operators must balance fish health and number of mortalities against operational requirements to move the population in a limited window of time.

Improvements in approaches for transferring or transporting fish are desirable.

### BRIEF DESCRIPTION OF THE FIGURES

Embodiments of the present disclosure will now be described, by way of example only, with reference to the attached Figures.

FIG. 1 depicts a schematic diagram of an embodiment of a biomass densification system according to the present disclosure;

FIG. 2 depicts a flow diagram of an embodiment of a biomass densification system according to the present disclosure;

FIG. 3 depicts a biomass density profile from source population through to fish pump in the current industry standard approach to fish pump loading, using a suction bell;

FIG. 4 depicts a biomass density profile from source population through to fish pump in an embodiment of a biomass densification system according the present disclosure;

FIG. 5 illustrates a perspective view of an embodiment of a biomass densification system according to the present disclosure with a conversion zone and a loading zone;

FIG. 6 illustrates a perspective view of an embodiment of a biomass densification system according to the present disclosure configured with a conversion zone and a loading zone and with an attraction current generation unit;

FIG. 7 illustrates an exploded view of the biomass densification filter unit, of in the embodiments shown in FIGS. 5 and 6;

FIG. 8A and FIG. 8B illustrate two cross-sectional views of an embodiment of a biomass densification filter of a biomass densification system according to the present disclosure;

FIG. 9 illustrates a cross sectional view of an embodiment of a biomass densification system according to the present disclosure with the loading zone at the top of the unit;

FIG. 10 illustrates a perspective view of an embodiment of a biomass densification system according to the present disclosure configured with a multi-nozzle flow multiplication unit and with a curved biomass densification unit body;

FIG. 11 illustrates a perspective view of an embodiment of a biomass densification system according to the present disclosure configured with a multi-nozzle flow multiplication unit and with a curved biomass densification unit body detached from the flow multiplication unit;

FIG. 12 illustrates a cross-sectional view of an embodiment of a biomass densification system according to the present disclosure configured with a multi-nozzle flow multiplication unit and with a curved biomass densification unit body;

FIG. 13 illustrates a cut-away view of an embodiment of a biomass densification system according to the present disclosure configured with a multi-nozzle flow multiplication unit and with the body of a biomass densification unit configured to curve about a densification filter;

FIG. 14 illustrates a cross-sectional view of an embodiment of a biomass densification unit configured to curve about a densification filter; and

FIG. 15 illustrates top, front, back and side views of an embodiment of a biomass densification system according to the present disclosure configured with a multi-nozzle flow multiplier unit and with the body configured to curve about the densification filter.

### DETAILED DESCRIPTION

Generally, the present disclosure provides a system and method for biomass densification. For example, for handling fish.

In one aspect, a biomass densification system is provided comprising: a biomass densification unit having a body defining an inlet and an outlet and comprising a densification filter on the body, the inlet configured to receive an input stream including a target biomass and having a first biomass density, and the densification filter configured to allow fluid flow therethrough and configured to prevent passage of the target biomass therethrough; and a suction pump configured to produce a suction force across the densification filter at or below a threshold, the suction force configured to draw the input stream through the densification filter for producing a biomass residue stream separate from a filtrate stream, the biomass residue stream configured to direct the target biomass toward the outlet at a second biomass density, wherein the second biomass density is greater than the first biomass density.

In another aspect, a method of densifying biomass in a fluid is provided comprising: obtaining an input stream comprising a target biomass and having a first biomass density; providing a densification filter configured for allowing flow of the input stream therethrough and sized to prevent flow of the target biomass therethrough; and applying a suction force across the densification filter for filtering the target biomass from the input stream for generating a biomass residue stream separate from a filtrate stream.

For the purpose of promoting an understanding of the principles of the disclosure, reference will now be made to the features illustrated in the drawings and specific language will be used to describe the same. It will nevertheless be understood that no limitation of the scope of the disclosure is thereby intended. Any alterations and further modifications, and any further applications of the principles of the disclosure as described herein are contemplated as would normally occur to one skilled in the art to which the disclosure relates. It will be apparent to those skilled in the relevant art that some features that are not relevant to the present disclosure may not be shown in the drawings for the sake of clarity.

Certain terms used in this application and their meaning as used in this context are set forth in the description below. To the extent a term used herein is not defined, it should be given the broadest definition persons in the pertinent art have given that term as reflected in at least one printed publication or issued patent. Further, the present processes are not limited by the usage of the terms shown below, as all equivalents, synonyms, new developments and terms or processes that serve the same or a similar purpose are considered to be within the scope of the present disclosure.

Unless defined otherwise, all technical and scientific terms used herein have the meaning as commonly understood in the art.

As used in the specification and claims, the singular forms “a”, “an” and “the” include plural references unless the context dictates otherwise.

### Existing Approaches to Biomass Densification

The global fish farming industry, including the salmon farming industry for example, currently uses an inefficient process to handle the movement of fish, from one location to another, for instance, between net pens or tanks, or from farm to vessel. Existing approaches may include corralling large volumes of fish, thereby significantly increasing biomass density of the entire population to unsafe levels, as it is loaded for transport, for example, into a fish pump. This increased density can negatively impact the fish by potentially causing them to lose the ability to swim and may decrease oxygen levels, which may result in multiple negative physiological responses.

For example, salmon farming at sea may operate at a biomass density of up to about 25 kg/m³, notwithstanding that some organic standards requiring a biomass density of about 10 kg/m³ to about 15 kg/m³.

In a land-based salmon farming operation, a recirculating aquaculture system may have a biomass density of up to about 85 kg/m³, beyond which it may no longer maintain healthy water conditions for the salmon population by stripping away nitrogen, ammonia and other detrimental gasses and replacing them with oxygen. A fish pump may operate efficiently with about 90 kg/m³ to about 100 kg/m³ biomass density moving through the fish pump. Current industry standard transfer brings the average biomass density to about 300 kg/m³ to about 500 kg/m³ in order to supply the pump at about 90 kg/m³ to about 100 kg/m³.

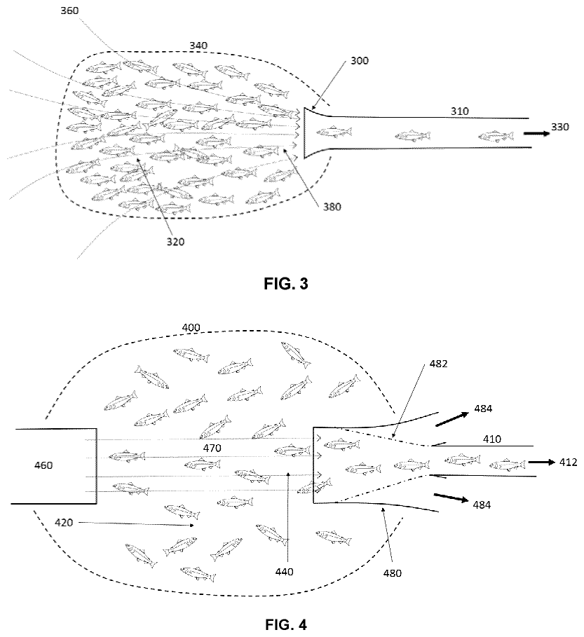

In the current industry approach to fish transfer (FIG. 3) using a fish pump and a suction bell, the point of highest biomass density is found in the source population of fish, waiting to be transferred. In a fish pumping system using biomass densification (FIG. 4), the point of highest biomass density may be shifted to the flow within the fish pump.

### Biomass Densification by Pressure Differential

With the use of biomass densification using a pressure differential, a pumping system may draw a fluid comprising a target biomass, such as water containing fish) and having a biomass density that is less than the optimal biomass density of the fish pump. A biomass densification unit may be used to increase the biomass density of the combination of fish and water before moving the combination of fish and water into the fish pump. The biomass density requirement for pump operation may thereby be met while keeping the source population biomass density within safe and healthy limits.

Embodiments of the present disclosure may use a pump to generate a pressure differential, for example negative pressure (suction). The pump may comprise a means for moving fluids, for example, a suction pump, a vacuum, a Bernoulli pipe, an eductor, a controlled pumping system, or other means, to create a suction force for stripping a fluid such as water away from biomass such as fish, in order to densify the biomass in a biomass pump or biomass pumping system, such as a fish pump or fish pumping system. The suction force may be applied across a filter sized to allow fluid flow through the filter with the filter configured to prevent passage of a target biomass through the filter.

In the current industrial approach, the entire source population of fish being loaded into the pump is physically crowded to a high biomass density in order to meet the requirements of the pump (FIG. 3).

With the addition of biomass densification by pressure differential, biomass density required for the source population at loading into the pump may be reduced (FIG. 4). The biomass density requirement for pump operation may thus be met while keeping the source population biomass density within safe and healthy limits, or otherwise controlled limits.

Said another way, in the current methods without biomass densification, the highest point of biomass density may be the source population due to the fish crowding themselves in an effort to move against a suction current away from the suction source and the point of lowest biomass density may be the flow within the pump.

With addition of biomass densification by pressure differential, the point of highest biomass density may be within the pump, and the density of the source population may be maintained at a lower biomass density in a loading zone. Accordingly, the biomass density of the source population may be maintained at less than the optimal biomass density in the pump since the biomass density increases between the source population and the pump.

### Biomass Density in Aquaculture

A fish pump may operate efficiently with about 90 kg/m³ to about 100 kg/m³ biomass density moving through the fish pump. However, current industry standard transfer can bring the average biomass density to about 300 kg/m³ to about 500 kg/m³ in order to supply the pump at about 90 kg/m³ to about 100 kg/m³.

Current commercial processes draw water through the fish population, drawing more water than fish and decreasing biomass density between the fish population and the pump because the fish may actively fight against the suction. Consequently, a high population biomass density is required to load a fish pump with the required biomass density to operate the pump efficiently according to previous approaches.

At a biomass densification unit, at least one suction pump may operate to produce negative pressure across a filter for creating a conversion flow in a loading zone. Consequently, biomass may be densified at the filter so the biomass may be rapidly and safely drawn into the pump without the negative effects of physical handling for extended periods of high stress. The balance of the population may be maintained in healthy, low stress conditions.

### Biomass Densification by Pressure Differential in Aquaculture

Biomass densification in aquaculture may involve the process of stripping away a volume of water but keeping biomass volume constant for increasing the biomass density or the proportion of biomass to water.

Biomass densification may be done by passing the water and biomass through a densification filter, such as a smooth grate or bars for example, to allow water to pass through the densification filter assisted by suction but prevent target biomass from passing through the filter.

The densification filter may form part of a biomass densification unit. The biomass densification unit may additionally have a body defining an inlet and an outlet. The inlet may be sized or otherwise configured to receive an input stream of fluid, for example water, including a target biomass, for example one or more fish such as salmon. The input stream may have a first biomass density.

The filter may be sized to prevent passage of the desired biomass through the filter. For example, a filter for salmon may use an about 0.5-inch gap spacing between bars. Additionally, the geometry of the gaps may be adjusted to protect fins of fish biomass to prevent the filter from pinching the fins. For example, the end of a gap may have a wide-angle flat surface such that the fins may slide out of the gap in a ramp-like manner. Alternatively, the smooth grate or bars may comprise a plurality of spaced-apart bars, each spaced apart bar narrowing in the direction of the inlet.

The water that passes through the densification filter may form a filtrate stream, while the fish that does not pass through the densification filter may form a biomass residue stream. The biomass density in the biomass residue stream may be greater than the biomass density in the input stream due to the removal of water.

The path followed by the biomass residue stream may lead to a pump suction, while the water that has passed through the biomass densification filter (filtrate stream) may be directed away from the biomass residue stream and follow negative pressure (suction) that may be applied to a side of the biomass densification filter opposite the biomass residue stream. The negative pressure may be calibrated to draw away water from the biomass.

### Flow Multiplication

Water flow requirements may define a system requirement for the input stream. If the input stream requirement is met directly using pumped water from a water supply originating above the water's surface, the weight and volume of water to be handled may limit the size of the biomass densification system that can be supported and thus the size of the fish pump that may be supported.

To support commercial scale biomass movement of fully grown fish, for example, an eductor-based system with self-regulating feedback to move the required volume of water at the desired flow rates may be used. An eductor-based system may use a smaller volume of water at higher pressure than previous approaches as a driving force.

The eductor system may use supply water from the surface (a draw) to move a larger body of water below the surface and create current flows as required by the system.

Pairing an eductor draw with a biomass densification unit may create suction pressure for stripping water from the biomass within safe limits, for example, for fish health.

Presence of varying amounts of biomass, for example fish, within the system may affect operating conditions of the water stripping of biomass densification unit. For instance, as biomass increases, water available to the water stripping suction may be reduced. Conversely, the amount of biomass blocking the suction may increase. The increasing biomass density may lead to an increasing suction pressure on the biomass. For safe fish operation, the pressure must be kept below a safety threshold.

In the eductor system, peak suction pressure may be relatively low compared to previous approaches and can be adjusted such that peak eductor suction pressure may be below the fish safety limit.

A multi-nozzle embodiment of the suction pump may be used to increase the flow multiplication effect and to create a larger output flow with more control of the flow velocity profile across the output flow.

A multi-nozzle embodiment of the suction pump may include one or more eductors in a flow multiplier unit that may be used to increase the flow multiplication effect and to create a larger output flow with more control of the flow velocity profile across the output flow.

By positioning multiple nozzles to increase the surface area in contact between the low-speed source water from the filtrate water stream and the high-speed supply water from the high-pressure supply, the Venturi effect may be increased and flow multiplication may be increased accordingly, increasing the volume of water in the output water stream. Positioning of multiple nozzles across the flow multiplication unit also allows for greater control of the flow velocity profile across the output water stream. CFD modelling may be used to simulate and optimize the positioning and sizing of the eductor nozzles within the flow multiplication unit, to create a desired output profile and to compute the flow multiplication effect and resulting flow velocity profile, based on the filtrate source water pressure and surface supply water pressure.

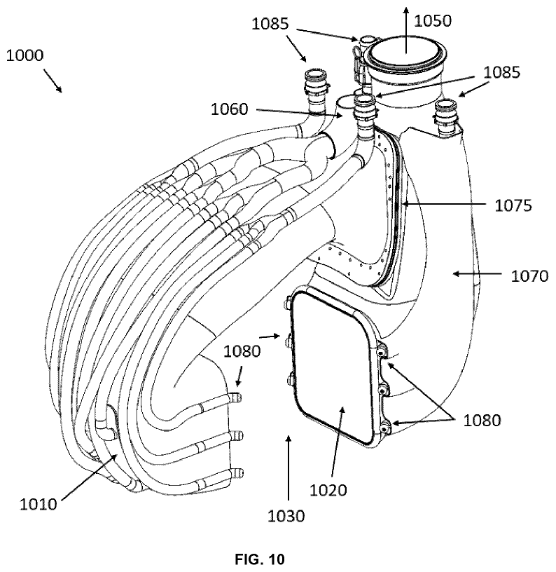

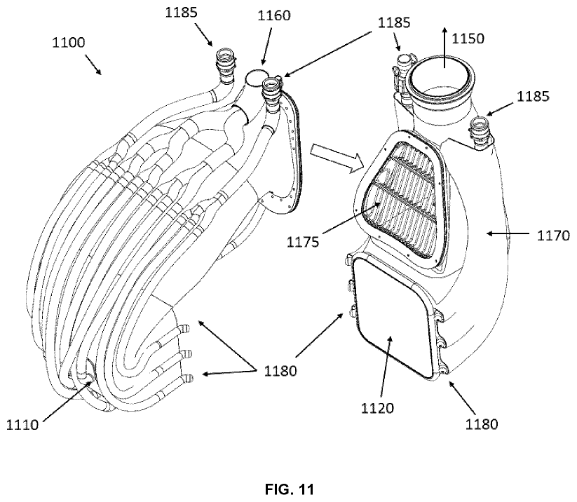

Embodiments of the multi-nozzle eductor based flow multiplication unit are shown in FIGS. 10 to 13 and 15. In this embodiment the nozzle count may be defined based on the cross-sectional area of the flow multiplication unit. A nozzle count of 40-80 nozzles per square meter may be used. The nozzle diameter and a supply water pressure may be chosen to create a pressure drop in the range of 25-35 psi across the nozzles, with support for up to 50 psi at the surface supply, to allow for system losses. This type of design may achieve flow multiplication factors of up to 20.

An embodiment using high levels of flow multiplication, through use of high-pressure supply water will create jets of high velocity water at the output of the eductor nozzles that may be harmful to fish. The flow multiplication unit may therefore be designed to prevent the ability of fish to swim into the output of the flow multiplication unit through use of a grate or the geometry of the flow multiplication unit output.

The geometry or size of a loading zone and the cross-sectional area of the conversion current may be scaled up or down depending on how much water is desired to be moved. The requirement for this sizing may depend on one or more fish pumps being supported and how much biomass densification may be supported.

### Regulation of a Pressure Differential in Aquaculture

Stripping away water by applying suction may be hazardous to certain types of biomass, for example animals such as fish, because as water is drawn away and the biomass density increases, a standard pump operating at a fixed number of revolutions per minute (“RPM”) may put increasing pressure on the animals. If not limited, the pressure may increase to the point of causing harm or injury.

A suction pump, for example the at least one eductor, may draw supply water from an above water level water supply for creating the conversion flow at the biomass densification unit. Additionally, eductor performance may be adjusted during operation, for example by adjusting or controlling source water pressure, to maintain flow multiplication within a target range. The target range may vary with depth and water pressure conditions.

### Biomass Densification Unit Design

The biomass densification unit may comprise a body defining an inlet and an outlet. The inlet may be sized or otherwise configured to receive an input stream of fluid, for example water, including a target biomass, for example one or more fish such as salmon. The input stream may have a first biomass density. The biomass densification unit may include a biomass densification filter on the body.

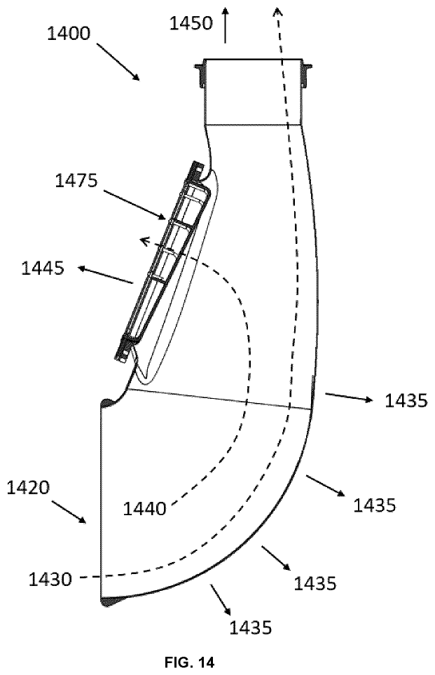

An embodiment of the biomass densification unit may be shaped to use centrifugal forces to improve the filtering and densification effects over using the filter alone. Embodiments of biomass densification systems which may include biomass densification units using centrifugal forces are shown in FIGS. 10 to 13 and 25. FIG. 14 shows an embodiment of the biomass densification unit that may comprise a biomass residue flow path between the input water stream and the biomass residue stream, and a filtrate flow path between the input stream through the filter to the stream. The biomass densification unit may be shaped such that the biomass residue flow path may widen and curve about the biomass densification filter. Centrifugal force may thereby create a biomass residue stream flow path around the outside of the curve that selects for biomass and guides the biomass residue stream within the water flow towards the outlet of the biomass densification unit.

The biomass densification unit body may be configured to curve about the densification filter for directing the biomass residue stream along an arcuate path about the densification filter in the direction of the outlet facilitated by centrifugal force.

### Biomass Attraction

Biomass densification by pressure differential may work in conjunction with biomass attraction approaches.

Biomass attraction may include a means to draw biomass actively or passively towards a biomass densification unit. Such approaches may include a means to facilitate voluntary swim-in (“VSI”) of fish into a biomass densification unit.

In some embodiments, a VSI approach may include generating an attraction current such that the need to force biomass into the pump by crowding may be obviated. The attraction current may work synergistically with the natural instincts of the biomass, such as fish, for directing the biomass towards the inlet of the biomass densification unit.

The attraction current may be generated by an attraction pump. The attraction pump may include, an attraction current pump, an attraction current vacuum, an attraction current Bernoulli pipe, an attraction current flow multiplier, an attraction current eductor, a plurality of attraction current eductors, a controlled pumping system, or other means for generating a current.

During most of their lifecycle, salmon and other farmed species naturally swim against the current. When presented with a fish pump drawing current towards the pump entry, the first will actively swim away from the pump entrance.

In contrast to known approaches, biomass densification according to some embodiments may attract fish into the system into the input stream efficiently, removing the need to force fish into the pump through crowding. Additionally, biomass density may be increased between entry into VSI suction flow and the entry to the pump suction.

An attraction current may be used in a biomass pumping system to create conditions leading up to, and at the entry to, the biomass pump that change the dynamic such that the instinctive behavior of the biomass, for example fish, is to swim toward the biomass densification unit. A pump, such as at least one eductor, may draw supply water from an above water level water supply to generate an attraction current that may be directed away from the biomass densification unit for drawing biomass into the system from the environment as the fish swim against the attraction current toward the biomass densification unit. The at least one eductor may use flow multiplication to multiply flow of the supply water and may generate an attraction current of a desired velocity.

Attraction current generation may work with or against the environmental water movements, for example, environmental fluid flow rate, tide at sea, tank dynamics on land or other factors, in order to produce an attraction current within a required range for attraction of a target fish species. For example, the required attraction current flow rate range for attraction of salmon is about 0.47 m/s.

Attraction pump performance may be adjusted during operation, for example by adjusting supply water pressure, to maintain an attraction current flow within a target range. The target range may vary with depth and water pressure conditions. For example, the attraction current flow rate at the attraction pump may be configured to be within a range of 0 m/s to 3 m/s for salmon. The flow rate may be controlled and selected based on environmental factors such that an attraction current flow rate of about 0.47 m/s is attained once environmental effects on the attraction current, such as depth and pressure, are realized.

### Biomass Conversion

Biomass densification by pressure differential may work in conjunction with biomass conversion approaches.

Biomass conversion approaches may, in turn, work in conjunction with biomass attraction approaches.

Biomass conversion may include a means to direct biomass towards or otherwise into the biomass densification unit or facilitate entry of biomass into the biomass densification unit, for example, from the environment or from an attraction current. Such approaches may include a means to facilitate VSI.

A VSI approach may include generating a conversion current such that as target biomass, for example a fish, approaches the inlet of the biomass densification unit, the target biomass is carried into the inlet of the biomass densification unit.

The conversion current may be generated by a conversion pump. The conversion pump may include, a conversion current pump, a conversion current vacuum, a conversion current Bernoulli pipe, a conversion current flow multiplier, a conversion current eductor, a controlled pumping system, or other means for generating a current. The conversion pump may be the same unit or a different unit to the suction pump.

The conversion pump may be configured to direct water from a water source (source water) adjacent to the inlet for producing the conversion current in the direction of the biomass densification unit inlet.

Source water may be derived from the filtrate water stream.

The conversion pump may be configured to direct the filtrate water stream adjacent to the inlet for producing the conversion current in the direction of the biomass densification unit inlet.

The conversion current may be configured to recirculate water from the filtrate water stream into the conversion current, and into the inlet stream.

The conversion pump may direct the conversion current into the inlet of the biomass densification unit. The conversion current may be oriented to form a cross-jet to an attraction current.

Fish swimming against the attraction current and in the direction of the biomass densification unit may pass into the cross-jet formed by the conversion current. The biomass may be caught by the conversion current and thus be guided into the biomass densification unit to form an input stream, where the suction pump may then be configured to operate across a biomass densification filter and configured to remove water from the input stream and generate a filtrate stream and a biomass residue stream.

The fish may encounter the conversion current broadside such that the fish's ability to swim out of the conversion current is reduced, thereby facilitating the fish's presence in the input stream.

Biomass in the environment or in the attraction current may thus be guided into the inlet of the biomass densification unit.

Velocity of a conversion current may depend on the target size and species of biomass, for example, fish, as well as the pumping system being supported. For instance, the target velocity may be from about 2 m/s to about 2.5 m/s in salmon applications and may be controlled or otherwise selected in consideration of environmental factors such as flow rate, tide, to generate a flow rate within a target range.

The conversion current may be a faster moving volume of water than the target attraction current flow range in order to move the biomass, for example fish, into a VSI from a loading zone.

The suction pump and/or conversion pump may be configured to draw fluid from a high-pressure supply, such as from the supply water. The pressure of the supply water may be adjusted to facilitate maintaining a conversion current flow rate within a target range.

The conversion pump may be the same unit or a different unit to the suction pump.

### Autoregulation of a Pressure Differential and Flow Multiplication

As biomass density increases at the filter, the filter's resistance to water flow may increase such that the negative pressure applied by a pump such as an eductor may not increase. The at least one eductor may thus reach a maximum suction pressure. The filtrate water stream and the suction force may thus act in opposing directions configured to create a water flow and pressure feedback loop to enable self-regulation of the biomass densification system. This change in dynamic allows the operator to maximize the fish pump transfer rate without compromising fish health and improves the overall efficiency of the pumping process by removing the need to compromise fish transfer rate to mitigate damage to the fish population health.

Two functions of the eductor may be performed separately. Suction for the biomass densification filter and flow multiplication in the creation of a conversion current in the loading zone may be performed efficiently by an eductor, requiring no moving parts or additional power. The suction force for the biomass densification filter may be provided by a pump, providing its maximum suction pressure can be limited below the biomass safety threshold. The flow multiplication function can be performed at the surface, by increasing the volume of water pumped from a pump water supply or be performed below the surface with the addition of subsurface pump capacity.

A feedback or regulation mechanism may therefore be used in order to modulate the stripping water such that the target biomass density may be achieved without exceeding a safe pressure threshold.

The feedback mechanism may form part of a controlled pumping system wherein a control system may sense the suction pressure and adjust the operation of the suction pump such that the suction pressure may be kept below a threshold. The threshold may correspond with biomass safety standards.

Alternatively, or in addition, the feedback or regulation mechanism may comprise connecting the filtrate stream to the conversion stream. For example, the suction pump comprising one or more eductors may create a suction pressure that is limited and may level off at a peak suction pressure if the water source is restricted. The one or more eductors may be configured such that the peak suction pressure may be kept at or below a safety threshold for the biomass, for example fish. If biomass density rises, the one or more educators' source water supply may be restricted, flow multiplication of the one or more eductors may decrease, which may in turn reduce the conversion flow rates and uptake of additional biomass.

The at least one eductor may be a passive unit in alignment with water flow and may not have moving parts. The at least one eductor may operate below water level and may not require any addition of power.

The at least one eductor may be sized to produce the desired fluid flow based on a ratio of its Venturi throat diameter and eductor nozzle diameter, for example a ratio of about 0.30 to about 0.75.

### EXAMPLES

To gain a better understanding of the invention described herein, the following examples are set forth. It should be understood that these examples are for illustrative purposes only. Therefore, they should not limit the scope of this invention in anyway.

In one aspect, a biomass densification system is provided comprising: a biomass densification unit having a body defining an inlet and an outlet and comprising a densification filter on the body, the inlet configured to receive an input stream including a target biomass and having a first biomass density, and the densification filter configured to allow fluid flow therethrough and configured to prevent passage of the target biomass therethrough; and a suction pump configured to produce a suction force across the densification filter at or below a threshold, the suction force configured to draw the input stream through the densification filter for producing a biomass residue stream separate from a filtrate stream, the biomass residue stream configured to direct the target biomass toward the outlet at a second biomass density, wherein the second biomass density is greater than the first biomass density.

In another aspect, a method of densifying biomass in a fluid is provided comprising: obtaining an input stream comprising a target biomass and having a first biomass density; providing a densification filter configured for allowing flow of the input stream therethrough and sized to prevent flow of the target biomass therethrough; and applying a suction force across the densification filter for filtering the target biomass from the input stream for generating a biomass residue stream separate from a filtrate stream.

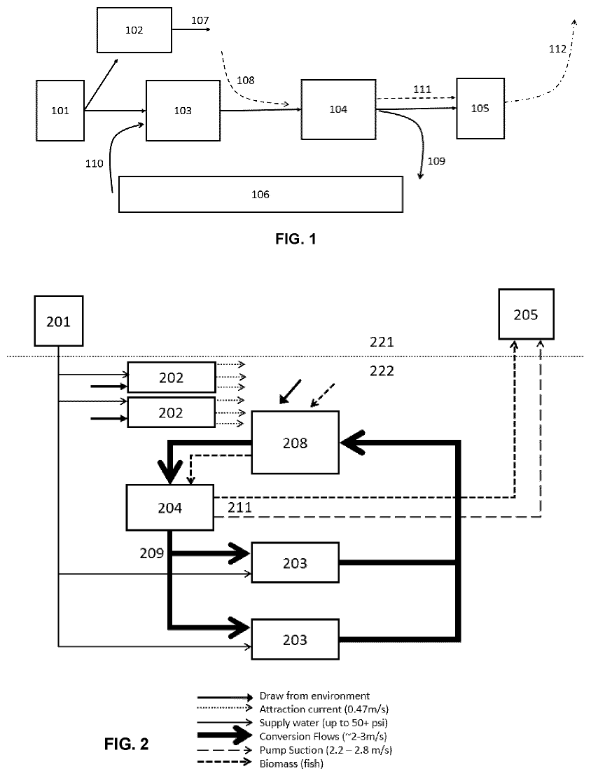

FIG. 1 depicts a functional diagram of an embodiment of a biomass densification system according to the present disclosure. The process flow is shown in FIG. 1 starting with a water supply unit 101 supplying water to an attraction current pump 102 and a flow multiplication unit 103. The attraction current pump 102 may generate an attraction current 107 in the vicinity of the loading zone 108 creating conditions leading up to the loading zone 108 that encourage fish to swim into the loading zone 108. The flow multiplication unit 103 may draw supply water from the supply water unit 101 and recirculated filtrate water 110 to produce water flows through the loading zone 108 towards an inlet of the biomass densification unit 104, creating conversion currents in the loading zone 108. The conversion currents may be configured such that fish that enter the conversion currents are rapidly and safely drawn into the biomass densification unit 104. The biomass densification unit 104 may draw fish and water from the loading zone 108 as part of an input stream at an input biomass density. The biomass densification unit 104 may strip water from the input stream of fish and water by applying suction pressure across a filter that may allow passage of water but not fish, producing a filtrate water stream 109 that may be recirculated back towards the flow multiplication unit 103 and a biomass residue stream 111 that is directed towards the pump suction 105 and an outlet of the biomass densification unit 104 to the fish pump at an output biomass density 112. The filtrate stream 109 may be pumped back to the input of the flow multiplication unit through the racetrack 106 as recirculated filtrate water 110.

The flow multiplication unit 103 may be implemented using one or more eductors configured to draw from the recirculated filtrate water 109 with a maximum suction pressure which is below a threshold such the suction pressure at the biomass densification unit 104 is below a safety threshold for the health of the fish passing from the biomass densification input stream to the biomass residue stream. As the biomass density in the biomass densification unit rises and restricts that passage of water through the biomass densification filter, and the suction pressure of the flow multiplication eductors reach their maximum threshold, the flows from the flow multiplication unit may be reduced, decreasing the conversion currents in the loading zone and reducing the uptake of additional biomass. Thus, a self-regulating feedback system is created in which biomass density and water flow or water pressure is mainlined within a safe zone for the fish or other biomass being drawn into the system. This may, for example, mitigate risk of injury or damage.

FIG. 2 depicts a flow diagram of an embodiment of a biomass densification system according to the present disclosure that may be implemented in a fish cage or tank and in use with a fish pump. In this embodiment a water supply unit 201 may be positioned above water level 221 provides water at a source pressure of up to 50 psi, to at least two eductor-based attraction current generators 202 and at least two eductor-based flow multiplication units 203 positioned below water level 222. The attraction current generators 202 may use high pressure water from the water supply unit 201 along with water drawn from the local environment to create an attraction current zone with flows of about 0.47 m/s. The flow multiplication units may take high pressure supply water from the water supply unit 201 and recirculated filtrate water 209 from the biomass densification unit 204 and together produces conversion flows through the loading zone 208 towards the biomass densification unit 204 with flow rates from about 2 m/s to about 3 m/s. The biomass densification unit may draw water and biomass from the loading zone 208 at an input biomass density and produces a filtrate water stream 209 that is recirculated back towards the flow multiplication units 203 and a biomass residue stream 211 at an output biomass density that is directed towards the fish pump suction, which has a target flow rate of about 2.2 to about 2.8 m/s. The fish pump suction may connect to a fish pump above the water surface 205.

The flow multiplication unit eductors 203 may draw from the recirculated filtrate water 209 with a maximum suction pressure which is below a threshold such the suction pressure at the biomass densification unit 204 may be below a safety threshold for the health of the fish passing from the biomass densification input stream to the biomass residue stream. As the biomass density in the biomass densification unit rises and restricts that passage of water through the biomass densification filter, and the suction pressure of the flow multiplication eductors reach their maximum threshold, the flows from the flow multiplication unit are reduced, decreasing the conversion currents in the loading zone and reducing the uptake of additional biomass. Thus, a self-regulating feedback system may be created in which biomass density and water flow or water pressure is mainlined within a safe zone for the fish or other biomass being drawn into the system. This may, for example, mitigate risk of injury or damage.

FIG. 3 depicts a biomass density profile from source population through to fish pump in the current industry standard approach to fish pump loading, using a suction bell 300. The point of highest biomass density may be found in the source population of fish 320 as they swim away from the suction current 360. From there, the biomass density decreases in the direction of the suction flow, with the point of lowest biomass density found in the flow within the fish pump.

The source population of fish 320 is drawn together using a net 340 bringing the source population up to a population biomass density (PBD). A suction bell 300 is placed in the net 340 and is connected to a fish pump (not shown) with fish pump suction 330. The fish pump suction draws water and fish from the loading zone 380 at the mouth of the suction bell 300 through the hose 310 towards the fish pump. The fish may instinctively swim against the suction current 360 away from the loading zone 380 creating a loading zone biomass density (LZBD) that is less than the PBD. With the fish swimming against the current, the fish pump suction 330 may draw proportionally more water from the loading zone 380 than biomass, resulting in a pump suction biomass density (PSBD) that is less than the LZBD.

FIG. 4 depicts the biomass density profile from source population 420 through to fish pump in an embodiment of a biomass densification system according to the present disclosure. The point of highest biomass density may be found in the flow towards the fish pump 412. From there the biomass density decreases across the biomass densification unit to the pump loading zone 440.

The source population of fish 420 may be drawn together using a net 400 bringing the source population up to a PBD. A biomass densification system with a flow multiplication unit 460 and biomass densification unit 480 may be placed within the net, configured to produce a conversion zone 470 by producing conversion currents from the flow multiplication unit 460 towards the biomass densification unit 480, through the loading zone 440. The conversion current may be configured such that fish that enter the conversion current are rapidly and safely drawn into the biomass densification unit 480. The conversion currents are kept hidden from the source population of fish, such that fish voluntarily swim from the source population into the conversion currents and the loading zone, yielding a LZBD that is approximately equal to the PBD. Optionally, attraction currents (not shown) can be used to create an attraction zone adjacent to the conversion zone, attracting fish to swim into the conversion currents and creating a LZBD that is higher than the PBD. The biomass densification unit is connected to a fish pump (not shown) with a fish pump suction 412 using a hose 410. Filtrate suction 484 may be applied across the biomass densification filters 482, producing filtrate water streams (not shown) and a biomass residue stream in the suction hose 410 with a PSBD which is higher than the LZBD. Thus, the biomass densification system increases the biomass density of the biomass stream passing from input (loading zone 440) to output (fish pump suction 412).

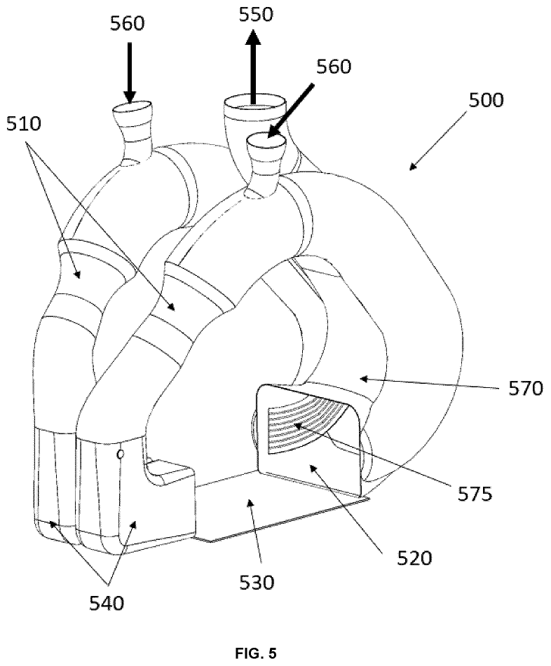

FIG. 5 illustrates a perspective view of an embodiment of a biomass densification system 500 according to the present disclosure configured with the conversion zone 530 and loading zone 520 at the lowest most end of the unit. The illustrated embodiment may include a pair of flow multipliers 510, conversion current generating nozzles 540, a biomass densification unit 570, biomass densification filter 575, and connection points for supply water 560 and pump suction 550.

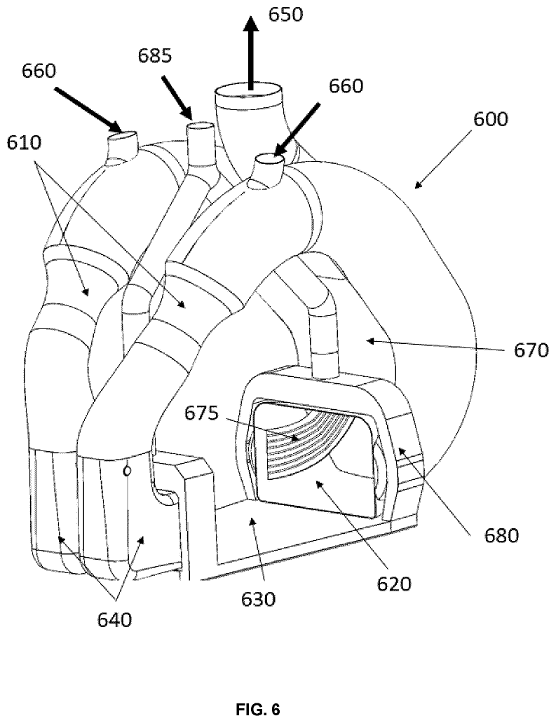

FIG. 6 illustrates a perspective view of an embodiment of a biomass densification system 600 according to the present disclosure configured with the conversion zone 630 and loading zone 620 at the lowest most end of the unit and with an attraction current generation unit 680. The illustrated embodiment may include a pair of flow multipliers 610, conversion current generating nozzles 640, a biomass densification unit 670, biomass densification filter 675, and connection points for flow multiplier supply water 660, attraction current generator supply water 685 and pump suction 650.

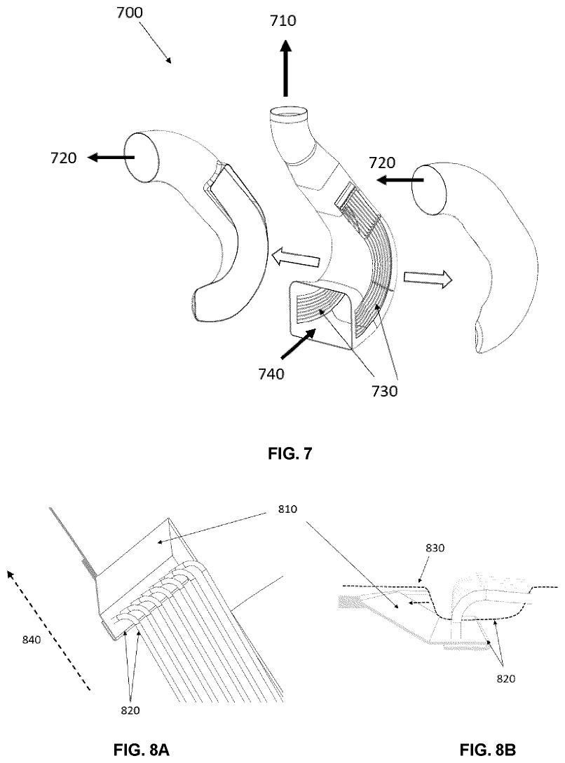

FIG. 7 illustrates an exploded view of the biomass densification filter unit 700, as implemented in the embodiments shown in FIGS. 5 and 6. FIG. 7 shows pump suction 710, flow multiplier eductor suction and filtrate water stream 720, biomass densification filter 730, input flow from loading zone 740.

FIG. 8A and FIG. 8B illustrate two cross-sectional views of an embodiment of a biomass densification filter of a biomass densification system according to the present disclosure. FIG. 8A and FIG. 8B illustrate the smooth angled plate, which may be shaped to protect fish fins as they move along the filter 810 and the distance between the filter bars and the smooth plate 820 which may be sized to be larger than the fish fin height shown by the fin profile and direction arrow 830. Fish may move through the filter in the direction of water flow 840.

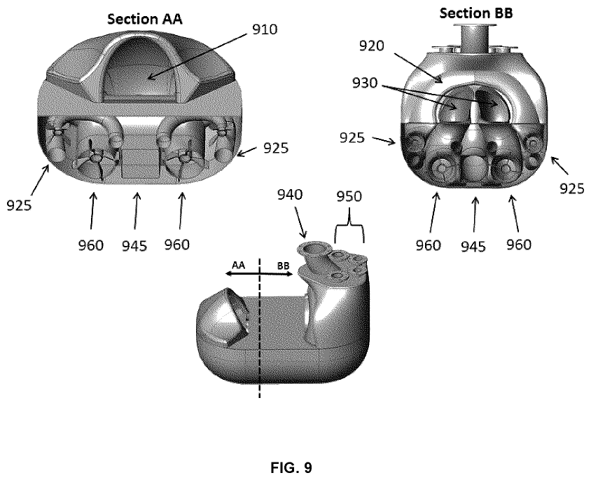

FIG. 9 illustrates a cross sectional view of an embodiment of a biomass densification system according to the present disclosure with the loading zone at the top of the unit. FIG. 9 illustrates the loading zone suction 910, the attraction current generator 920, the attraction current generator eductors 925, the conversion current nozzles 930, the pump suction output 940, the pump suction 945, the supply water inputs 950 and the flow multiplier eductors 960.

FIG. 10 illustrates a perspective view of an embodiment of a biomass densification system 1000 according to the present disclosure, which may be configured with a multi-nozzle flow multiplication unit 1010 and with the body of a biomass densification unit 1070 configured to curve about a densification filter 1075 for directing the biomass residue stream along an arcuate path about the densification filter. FIG. 10 illustrates a loading zone 1020, a conversion zone 1030, pump suction 1050, flow multiplier supply water input 1060, attraction current generator supply water inputs 1085, and attraction current generation nozzles 1080.

FIG. 11 illustrates a perspective view of an embodiment of a biomass densification system 1100 according to the present disclosure configured with a multi-nozzle flow multiplication unit 1110 and with the body of a biomass densification unit 1170 configured to curve about a densification filter 1175 with the biomass densification unit detached from the flow multiplication unit. FIG. 11 illustrates a loading zone 1120, pump suction 1150, flow multiplier supply water input 1160, attraction current generator supply water inputs 1185, and attraction current generation nozzles 1180.

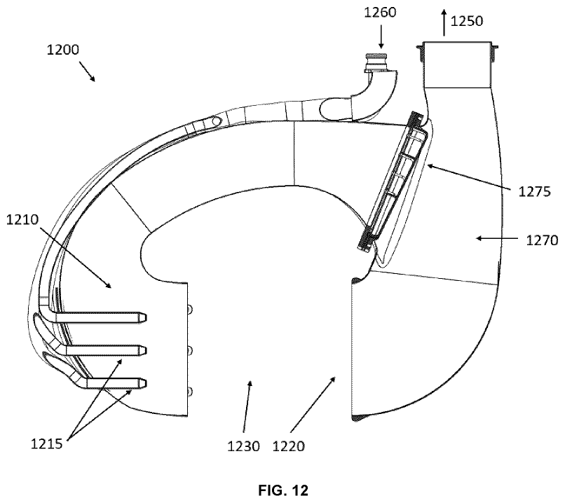

FIG. 12 illustrates a cross-sectional view of an embodiment of a biomass densification system 1200 according to the present disclosure configured with a flow multiplication unit 1210 with multiple nozzles 1215 and with the body of a biomass densification unit 1270 configured to curve about a densification filter 1275. FIG. 12 illustrates a loading zone 1220, a conversion zone 1230, pump suction 1250, and flow multiplier supply water input 1260.

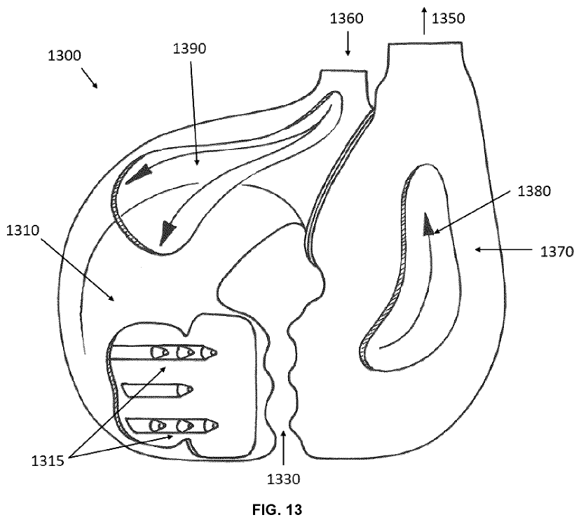

FIG. 13 illustrates a cut-away view of an embodiment of a biomass densification system 1300 according to the present disclosure configured with a flow multiplication unit 1310 with multiple nozzles 1315 and with the body of a biomass densification unit 1370 configured to curve about a densification filter. FIG. 13 illustrates a loading zone 1330, pump suction 1350, flow multiplier supply water input 1360 and shows flow through the biomass densification unit 1380 and supply water flow to the multi-nozzle flow multiplication unit 1390.

FIG. 14 illustrates a cross-sectional view of an embodiment of a biomass densification unit 1400 configured to curve about a densification filter 1475. Centrifugal forces 1435 direct the biomass residue stream 1430 along an arcuate path about the densification filter. FIG. 14 also illustrates a suction draw across the biomass densification filter 1445, the resulting filtrate flow path 1440, the loading zone 1420, and the pump suction output 1450.

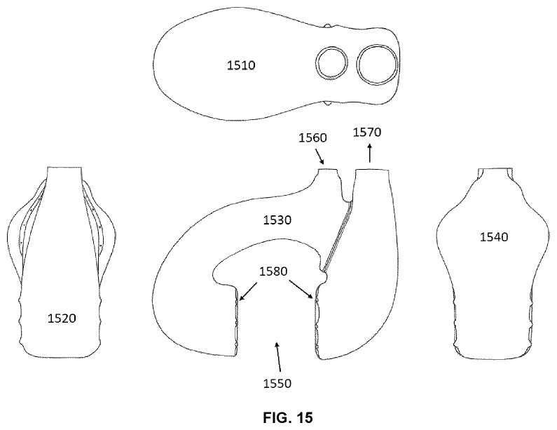

FIG. 15 illustrates top 1510, front 1520, back 1540 and side 1530 views of an embodiment of a biomass densification system according to the present disclosure configured with a multi-nozzle flow multiplier unit and with the body configured to curve about the densification filter. FIG. 15 illustrates the profile of the biomass densification system with conversion and loading zones 1550, attraction current generator nozzles 1580, pump suction output 1570 and supply water input 1560.

### Additional Embodiments

In some aspects, the disclosure relates to biomass densification using a pressure differential and related methods according to the following Embodiments, among others:
Embodiment 1. A biomass densification system comprising: a biomass densification unit having a body defining an inlet and an outlet and comprising a densification filter on the body, the inlet configured to receive an input stream including a target biomass and having a first biomass density, and the densification filter configured to allow fluid flow therethrough and configured to prevent passage of the target biomass therethrough; and a suction pump configured to produce a suction force across the densification filter at or below a threshold, the suction force configured to draw the input stream through the densification filter for producing a biomass residue stream separate from a filtrate stream, the biomass residue stream configured to direct the target biomass toward the outlet at a second biomass density, wherein the second biomass density is greater than the first biomass density.
Embodiment 2. The biomass densification system of Embodiment 1, wherein the suction pump comprises at least one flow multiplier eductor configured to have a maximum suction force across the densification filter that is at or below the threshold.
Embodiment 3. The biomass densification system of Embodiment 1 or Embodiment 2, wherein the suction pump comprises a plurality of nozzles in fluid communication with the filtrate stream.
Embodiment 4. The biomass densification system of any one of Embodiments 1 to 3, wherein the suction pump comprises a controlled pumping system.
Embodiment 5. The biomass densification system of any one of Embodiments 1 to 4, further comprising a conversion pump configured to direct a source water stream adjacent to the inlet to create a conversion zone.
Embodiment 6. The biomass densification system of Embodiment 5, wherein the source water stream comprises the filtrate water stream.
Embodiment 7. The biomass densification system of Embodiment 5 or 6, wherein the suction pump and the conversion pump cooperate to create a loading zone in fluid communication with the inlet configured to guide the target biomass through the inlet.
Embodiment 8. The biomass densification system of any one of Embodiments 5 to 7, wherein the suction pump and/or conversion pump is configured to draw a fluid from a high-pressure supply, the pressure of the high-pressure supply being adjustable for maintaining a conversion current flow rate within a target range.
Embodiment 9. The biomass densification system of Embodiments 8, wherein the target range of the conversion current flow rate is about 2 m/s to about 2.5 m/s.
Embodiment 10. The biomass densification system of any one of Embodiments 5 to 9, wherein when the suction force reaches the threshold, the conversion pump reduces the conversion flow rate for returning the suction force below the threshold.
Embodiment 11. The biomass densification system of any one of Embodiments 1 to 10, further comprising an attraction pump configured to generate an attraction current for directing the target biomass toward the inlet.
Embodiment 12. The biomass densification system of Embodiment 11, wherein the attraction pump comprises at least one attraction current eductor.
Embodiment 13. The biomass densification system of Embodiment 11, wherein the attraction pump is configured to generate the attraction current having a flow rate from a supply source, the supply source having a supply source pressure for controlling the attraction current flow rate within a target range.
Embodiment 14. The biomass densification system of Embodiment 13, wherein the attraction current flow rate is from about 0 m/s to about 3 m/s.
Embodiment 15. The biomass densification system of any one of Embodiments 1 to 14, wherein the densification filter comprises a grate including a plurality of spaced-apart bars.
Embodiment 16. The biomass densification system of any one of Embodiments 1 to 17, wherein the body is curved about the densification filter for directing the biomass residue stream along an arcuate path about the densification filter in the direction of the outlet.
Embodiment 17. A method of densifying biomass in a fluid comprising: obtaining an input stream comprising a target biomass and having a first biomass density; providing a densification filter configured for allowing flow of the input stream therethrough and sized to prevent flow of the target biomass therethrough; and applying a suction force across the densification filter for filtering the target biomass from the input stream for generating a biomass residue stream separate from a filtrate stream.
Embodiment 18. The method of Embodiment 17, further comprising recirculating the filtrate stream back toward the densification filter to create a conversion zone.
Embodiment 19. The method of Embodiment 17 or 18, further comprising providing a fluid supply and pumping the fluid supply to create an attraction current, the attraction current configured to attract the target biomass toward the densification filter.
Embodiment 20. The method of any one of Embodiments 17 to 19, further comprising providing a flow control stream having a flow control pressure and adjusting, using the flow control stream, the flow control pressure for maintaining the filtrate stream flow rate within a target range.
Embodiment 21. The method of Embodiment 20, wherein the filtrate stream has a filtrate stream flow rate through the conversion zone from about 2 m/s to about 2.5 m/s.

The embodiments described herein are intended to be examples only. Alterations, modifications, and/or variations can be effected to the particular embodiments those of skill in the art. The scope of the claims should not be limited by the particular embodiments set forth herein but should be construed in a manner consistent with the specification as a whole.

The aspects, embodiments, and/or examples of the present disclosure being thus described, it should be recognized that said aspects, embodiments, and/or examples may be varied in ways that do not depart from the spirit and scope of the present disclosure, and that said variations are intended to be included within the scope of the following claims.

All publications, patents and patent applications mentioned in this specification are herein incorporated by reference to the same extent as if each individual publication patent, or patent application was specifically and individually indicated to be incorporated by reference.

What is claimed is:

1. A biomass densification system comprising:
a biomass densification unit having a body defining an inlet and an outlet and comprising a densification filter on the body, the inlet configured to receive an input stream including a target biomass and having a first biomass density, and the densification filter configured to allow fluid flow therethrough and configured to prevent passage of the target biomass therethrough; and
a suction pump configured to produce a suction force across the densification filter at or below a threshold, the suction force configured to draw the input stream through the densification filter for producing a biomass residue stream separate from a filtrate stream, the biomass residue stream configured to direct the target biomass toward the outlet at a second biomass density, wherein the second biomass density is greater than the first biomass density.

2. The biomass densification system of claim 1, wherein the suction pump comprises at least one flow multiplier eductor configured to have a maximum suction force across the densification filter that is at or below the threshold.

3. The biomass densification system of claim 1, wherein the suction pump comprises a plurality of nozzles in fluid communication with the filtrate stream.

4. The biomass densification system of claim 1, wherein the suction pump comprises a controlled pumping system.

5. The biomass densification system of claim 1, further comprising a conversion pump configured to direct a source water stream adjacent to the inlet to create a conversion zone.

6. The biomass densification system of claim 5, wherein the source water stream comprises the filtrate water stream.

7. The biomass densification system of claim 5, wherein the suction pump and the conversion pump cooperate to create a loading zone in fluid communication with the inlet configured to guide the target biomass through the inlet.

8. The biomass densification system of claim 5, wherein the suction pump and/or conversion pump is configured to draw a fluid from a high-pressure supply, the pressure of the high-pressure supply being adjustable for maintaining a conversion current flow rate within a target range.

9. The biomass densification system of claim 8, wherein the target range of the conversion current flow rate is about 2 m/s to about 2.5 m/s.

10. The biomass densification system of claim 5, wherein when the suction force reaches the threshold, the conversion pump reduces the conversion flow rate for returning the suction force below the threshold.

11. The biomass densification system of claim 1, further comprising an attraction pump configured to generate an attraction current for directing the target biomass toward the inlet.

12. The biomass densification system of claim 11, wherein the attraction pump comprises at least one attraction current eductor.

13. The biomass densification system of claim 11, wherein the attraction pump is configured to generate the attraction current having a flow rate from a supply source, the supply source having a supply source pressure for controlling the attraction current flow rate within a target range.

14. The biomass densification system of claim 13, wherein the attraction current flow rate is from about 0 m/s to about 3 m/s.

15. The biomass densification system of claim 1, wherein the densification filter comprises a grate including a plurality of spaced-apart bars.

16. The biomass densification system of claim 1, wherein the body is curved about the densification filter for directing the biomass residue stream along an arcuate path about the densification filter in the direction of the outlet.

17. A method of densifying biomass in a fluid comprising:
obtaining an input stream comprising a target biomass and having a first biomass density;
providing a densification filter configured for allowing flow of the input stream therethrough and sized to prevent flow of the target biomass therethrough; and
applying a suction force across the densification filter for filtering the target biomass from the input stream for generating a biomass residue stream separate from a filtrate stream.

18. The method of claim 17, further comprising recirculating the filtrate stream back toward the densification filter to create a conversion zone.

19. The method of claim 17, further comprising providing a fluid supply and pumping the fluid supply to create an attraction current, the attraction current configured to attract the target biomass toward the densification filter.

20. The method of claim 17, further comprising providing a flow control stream having a flow control pressure and adjusting, using the flow control stream, the flow control pressure for maintaining the filtrate stream flow rate within a target range.

21. The method of claim 18, wherein the filtrate stream has a filtrate stream flow rate through the conversion zone from about 2 m/s to about 2.5 m/s.
